(19) United States
(12) Patent Application Publication
(10) Pub. No.: US 2020/0346142 A1
(43) Pub. Date: Nov. 5, 2020

(54) FILTERS WITH DYNAMIC PORE SIZES

(71) Applicant: Halliburton Energy Services, Inc., Houston, TX (US)

(72) Inventors: Kevin G. Kleinguetl, Kingwood, TX (US); Brice Aaron Jackson, Houston, TX (US); Lawrence Joseph Herskowitz, Pearland, TX (US); Adam Dotson, Houston, TX (US)

(21) Appl. No.: 16/963,881

(22) PCT Filed: May 10, 2018
(86) PCT No.: PCT/US2018/031965

§ 371 Date: Jul. 22, 2020

(51) Int. Cl. B01D 35/02; B01D 35/30

(52) U.S. Cl. CPC B01D 35/02; B01D 2201/18; B01D 35/308

(57) ABSTRACT

A filtration assembly comprising can include a housing in fluid communication with an inlet for receiving waste water from a wellbore. The assembly can also include a filter device for filtering a substances from the waste water. The filtering device can include a plurality of pores that are sized and shaped to define first dimensions. The filter device may be configurable in response to stimulus for altering the dimensions of the plurality of pores of the filter device to define a second area that is different from the first area.

### TECHNICAL FIELD

The present disclosure relates generally to devices for use in separating select substances from a fluid mixture and, more particularly (although not necessarily exclusively), to systems and devices for filtering substances from waste water collected during subterranean formation drilling.

### BACKGROUND

During drilling of hydrocarbon bearing formations, run-off (e.g., waste water or slop) may be collected from the drilling platform or rig. The waste water can include oils, multipliers, and other substances whose disposal is regulated by environment laws or regulations. Because of these regulations, the slop is treated or disposed of in accordance with environmental rules. The slop may be collected and transported from the drilling platform to treatment centers, which can be both time consuming and costly. Reducing the amount of slop that is disposed of in accordance with environmental rules, while complying with any applicable regulations can provide a cost benefit to a drilling program.

### BRIEF DESCRIPTION OF THE DRAWINGS

FIG. 1 depicts a diagram of a filter system in accordance with an aspect of the present disclosure.

FIG. 2 depicts a partial cutaway view of a filter system in accordance with another aspect of the present disclosure.

FIG. 3A depicts a partial cutaway view of a filter system in accordance with another aspect of the present disclosure.

FIG. 3B depicts a partial cutaway view of the filter system of FIG. 3A following the application of a stimulus to a filter device of the filter system.

FIG. 4 depicts a partial cutaway view of a filter system in accordance with another aspect of the present disclosure.

FIG. 5 depicts a portion of a filter device in accordance with an aspect of the present disclosure.

FIG. 6 depicts a portion of a filter device in accordance with another aspect of the present disclosure.

FIG. 7A depicts a front view of the portion of a filter device in accordance with another aspect of the present disclosure.

FIG. 7B depicts a side view of the portion of the filter device of FIG. 7A in accordance with an aspect of the present disclosure.

FIG. 8 depicts a system diagram of a signal-processing module according to an aspect of the present disclosure.

FIG. 9 depicts a wellbore system that includes a filter system according to an aspect of the present disclosure

### DETAILED DESCRIPTION

Certain aspects and features of the present disclosure relate to filtering run-off (also referred to as “waste water” or “slop”) to remove substances that are further treated prior to disposal and to recover water that may be reused or disposed of with limited or no further treatment. For example, the recovered water may be discharged at sea or re-used in the drilling process or filtering process. The substances requiring further treatment that are filtered from the slop may be transported for treatment at a separate location. Separation of these substances from the slop can reduce the amount of material that is further treated before disposal, thereby reducing costs associated with the drilling process.

A filter system can include a filter device having a filter material. The filter material can define multiple pores. The size or dimensions of the pores can be dynamically adjusted to selectively filter out substances from the slop. The size or dimension of the pores can be adjusted in a variety of ways, for example but not limited to, via a signal to move mechanical parts, a chemical reaction, application of an electrical current, exposure to a select wavelength of light, change in temperature (e.g., increase or decrease in temperature), or other suitable stimulus for deforming the filter material (e.g., expanding, retracting, twisting, etc.).

The ability to control the size or dimensions of the pores of the filter material permits the filter to be adjusted to filter out specific substances that may be found in the slop. In addition, in some aspects, a filter system may also include a sensor for detecting substances within the slop. The sensor may be in communication with other computing devices or signal-processing modules for transmitting information about the substances detected within the slop. Based on the information transmitted by the sensor the size or dimensions of the pores of the filter device may be dynamically altered to a desired size or dimension intended to filter out specific substances from the slop.

The size and dimension of the pores may also be enlarged to permit ease of cleaning the filter device, for example by back flushing a fluid through the filter device to clean or dislodge materials from the filter device.

These illustrative aspects and examples are given to introduce the reader to the general subject matter discussed here and are not intended to limit the scope of the disclosed concepts. The following sections describe various additional features and examples with reference to the drawings in which like numerals indicate like elements, and directional descriptions are used to describe the illustrative aspects but, like the illustrative aspects, should not be used to limit the present disclosure.

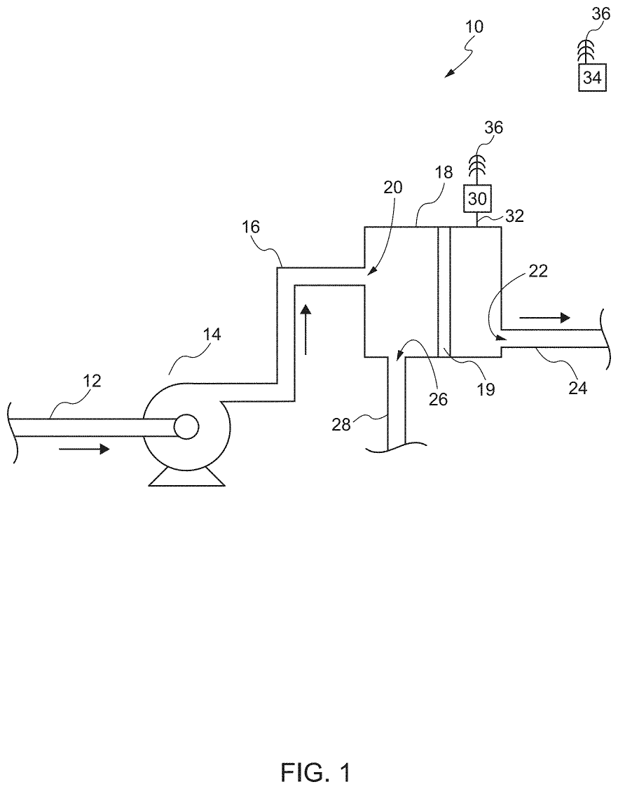

FIG. 1 depicts a filter system 10 for filtering substances from slop. The system 10 includes a fluid pathway (or piping) 12 through which slop may pass and a pump 14 that receives the slop and pumps the slop through a second fluid pathway or piping 16 to a filter apparatus 18. In some aspects the pump 14 may not be included and the slop may flow through a fluid pathway (for example but not limited to piping) via a gravitational force or other means. The slop enters the filter apparatus 18 via an inlet 20. The filter apparatus 18 may include a filter device 19 having multiple pores. The size or dimensions of the pores can be adjusted to a desired size or dimensions that is smaller than the size or dimensions of to filter out a certain substance (or substances) from the slop.

The water that passes through the filter device 19 (hereinafter “recovered water”) may exit the filter apparatus 18 at a water outlet 22. The water outlet 22 may be in fluid communication with a third fluid pathway (or piping) 24. The recovered water may exit the third fluid pathway 24 and be disposed of into the ocean or in other suitable manner. In some aspects, the water may be re-used on the drilling rig, for example during the drilling process or during the filtration process. The substances that did not pass through the filter device 19 may collect on an upstream side of the filter apparatus and may exit the filter apparatus 18 via a waste outlet 26. The waste outlet 26 may be in fluid communication with a fourth fluid pathway (or piping) 28. The substances exiting the filter apparatus 18 via the waste outlet 26 may pass through the fourth fluid pathway 28 to a storage container, to further filtering devices, or to other desired locations. Those substances may be further filtered, further treated or transported off the rig to a treatment site in accordance with environmental regulations. In some aspects, more or fewer pumps may be used, for example, additional pumps may move the substances through the fourth fluid pathway 28 or may move the recovered water through the third fluid pathway 24.

The filter device 19 may be in communication with a signal-processing module, for example controller 30, via a wired connection 32 or in some aspects a wireless connection. The controller 30 may transmit instructions to the filter device 19 that may control the pore size of the filter device 19. In some aspects, the pore size of the filter device 19 can be adjusted by transmitting or providing a stimulus to the filter device 19. The stimulus may include but is not limited to, a signal to move a mechanical part, application of a material to cause a chemical reaction, application of an electrical current, application of a select wavelength of light, application of a change in temperature, or other means suitable for altering the pore size of the filter device 19. In some aspects, the stimulus may cause a valve, including but not limited to an iris valve) to change position and thereby alter the size of the opening of the valve. In another aspect, the stimulus may cause a mechanical deformation of a filter material of the filter device 19. For example, the filter material may stretch in one or more directions which may cause the size and aspect ratio of a passageway (or pore) through the filter device 19. In yet another example, the filter device 19 may include an array of wires having a cross-sectional shape that can affect a passageway between the wires of the filter device 19 and thereby prevent certain materials from passing through the filter device 19. The orientation of the wires relative to one another in the array may affect the size and aspect ratio of the passageway between the wires of the filter device 19. In some aspects, the filter device 19 may include a plurality of strips (or blades) and the orientation of each of the plurality of strips can determine the size and aspect ratio of a passageway between each of the strips. For example, twisting the strips about their axis may change at least one of the size and aspect ratio of the passageway between adjacent strips. A second screen of strips may also be included in the filter device 19 to further control the size and aspect ratio of passageways through the filter device 19.

The controller 30 may be in communication with a computing device 34 via a wireless connection 36, though in some aspects a wired connection may be used. The computing device 34 may be located away from the filter apparatus 18. The computing device 34 may transmit instructions to the controller 30 for controlling the filter device 19, for example via the wireless connection 36. The instructions may include instructions for applying a stimulus to the filter device 19. The instructions may also include an amount of stimulus to apply to the filter device 19. The controller 30 may apply a stimulus to the filter device 19 in response to the signal from the computing device 39. In some aspects, the controller 30 may transmit a signal to the computing device 34. The signal may confirm the application of the stimulus or provide other information to the computing device 34. In some aspects only one of the controller 30 or the computing device 34 may be utilized.

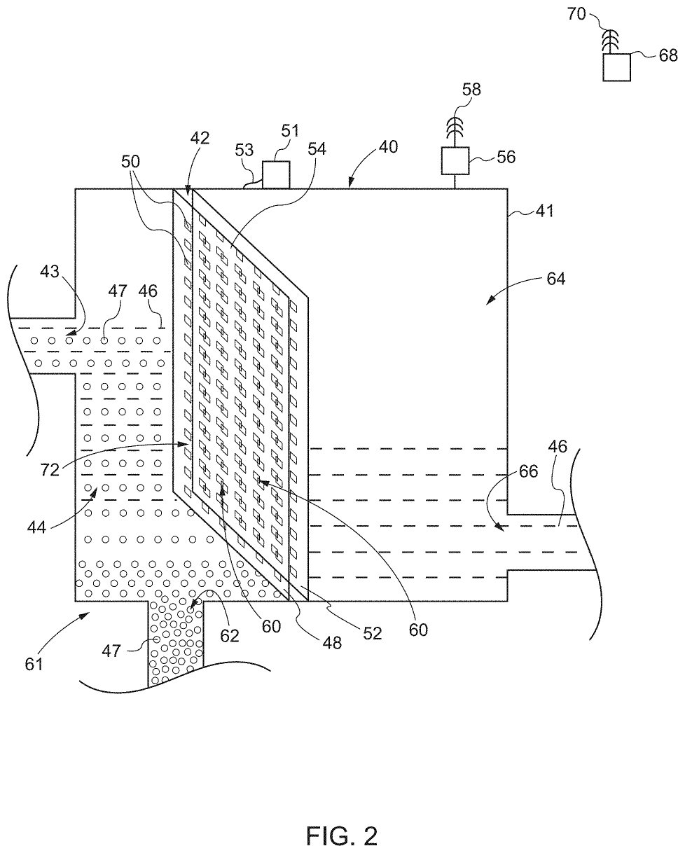

FIG. 2 depicts a filter apparatus 40 that includes a filter device 42 positioned within a housing 41. The filter apparatus 40 may be similar to the filter apparatus 18 shown in FIG. 1. Slop 44 may be pumped into the filter apparatus 40 via an inlet 43. The slop 44 may include water 46 and substances (or waste) 47. The substances 47 within the slop 44 may be for example toxic material or other waste material that requires additional treatment prior to disposal or special disposal. The filter device 42 may comprise a first screen 48 that includes multiple first openings 50. The first openings 50 may have dimensions defining an area of between about 1 μm and about 100 μm (for example but not limited to an area of between 1 μm-25 μm, 10 μm-50 μm, 25 μm-50 μm, 50 μm-75 μm, 40 μm-75 μm, or 75 μm-100 μm). The first openings 50 are shown having a generally rectangular shape, though any suitable shape may be used, including but not limited to triangular, circular, or oval. The filter device 42 may also include a second screen 52 that may include multiple second openings 54. The second openings 54 may have dimensions defining an area of between about 1 μm and about 100 μm (for example but not limited to an area of between 1 μm-25 μm, 10 μm-50 μm, 25 μm-50 μm, 50 μm-75 μm, 40 μm-75 μm, or 75 μm-100 μm). The second openings 54 are shown having a generally rectangular shape, though any suitable shape may be used, including but not limited to triangular, circular, or oval. The first openings 50 and the second openings 54 may be of the same or different sizes and shapes.

The first screen 48 may be moveable relative to the second screen 52. In some aspects, the second screen 52 may be moveable relative to the first screen 48. In the aspect of the present disclosure shown in FIG. 2, the second screen 52 is coupled to a motor 51 that is in in communication with a signal-processing module, for example controller 56 via a connection 58. The connection 58 may be wired or wireless. The controller 56 can transmit a signal to the motor 51 to position the second screen 52 in a desired position relative to the first screen 48. The position of the second screen 52 relative to the first screen 48 can determine the amount of overlap between the first openings 50 and the second openings 54. The overlap between the first openings 50 and the second openings 54 can define multiple pores, for example pores 60 shown in FIG. 2. Each of the pores 60 can have dimensions that define an area of the pore 60. For ease of viewing the first openings 50 and the second openings 54, the first and second screens 48, 52 are shown slightly separated in FIG. 2. Although the first screen 48 and the second screen 52 are shown spaced apart from one another in FIG. 2, this is done to permit a clearer view of the respective openings 50, 54. In use, the first screen 48 and the second screen 52 are positioned closely together and may be stacked together in contact with one another to define the pores 60. The dimensions of the pores 60 can define an area of each of the pores 60. The area of the pores 60 can be between about 0.1 μm and about 100 μm (for example but not limited to an area of between 0.1 μm-1 μm, 0.1 μm-10 μm, 0.5 μm-1.3 μm, 0.75 μm-1.5 μm, 1 μm-10 μm, 5 μm-25 μm, 10 μm-50 μm, 25 μm-50 μm, 50 μm-75 μm, 40 μm-75 μm, or 75 μm-100 μm). For example, the area of the pores 60 may be enlarged to 100 μm to permit cleaning of the filter. In some aspects, the area of the pores 60 may be between about 0.1 μm and about 10 μm to filter specific substances from the slop 44. The openings 50, 54 can be of any suitable size and shape, and thus the pores 60 can have varying sizes and shapes dependent upon both the size and shape of the openings 50, 54 and the overlap between those openings 50, 54. In some aspects additional screens may be used, for example to control the area of the pores 60 defined by the alignment of the openings in the plurality of screens.

The substances that can pass through the filter device 42 can be determined by the size of the pores 60. A substance that is larger than the pores 60 is prevented from passing through the first and second screens 48, 52 of the filter device 42, while a substance that is smaller than the size of the pores 60 passes through the filter device 42. For example, in some aspects the first and second screens 48, 52 may be aligned such that the pores 60 are sized to permit select substances, for example but not limited to water 46, to pass through the filter device 42 while preventing other larger substances, including but not limited to cuttings, sand, oil, and chemicals, from passing through the filter device 42.

As shown in FIG. 2, the substances 47 that cannot pass through the pores 60 of the filter device 42 can collect on a first side 61 of the filter device 42 and may exit the filter apparatus 40 via an outlet 62. The substances 47 can be collected for further treatment prior to disposal. The water 46 or other substances that are small enough to pass through the pores 60 can collect on the second side 64 of the filter device 42 and may exit the filter apparatus 40 via an outlet 66. The substances that have passed through the pores 60 of the filter device 42 and exited the filter apparatus 40 via the outlet 66 may be collected and disposed of without further treatment. For example, if the pores 60 were sized to permit only water and other non-toxic substances to pass through the filter device 42, the water and other non-toxic substances collected on the second side 64 of the filter device 42 may exit the filter apparatus 40 via the outlet 66 and be disposed without further treatment.

The size of the pores 60 is controlled by the positioning of the second screen 52 relative to the first screen 48. The controller 56 that is coupled to the motor 51 for controlling the position of the second screen 52 may be in communication with a computing device 68 located elsewhere via a wireless communication link 70. In some aspects, any of the above references wireless communication links could instead be wired communication links. In some aspects, the computing device 68 may be in direct communication with the motor 51 and the controller 56 may not be used. The controller 56 may receive instructions from the computing device 68 to position the screens 48, 52 to control the size of the pores 60.

The filter device 42 may be removable from the filter apparatus 40 for simplified cleaning. In some aspects, the water and non-toxic material that exits the filter apparatus 40 via the outlet 66 may be recycled for use in a drilling system, a filtration system, or otherwise disposed of. The position of the screens 48, 52 may also be altered to enlarge the size of the pores 60 to allow for easier cleaning of the filter device 42, for example by back flushing fluid through the filter device 42 towards the first side 61 of the filter device 42.

In some aspects, an optional coating, for example a coating 72 may be positioned on one or both of the filter screens 48, 52. The coating 72 may be a hydrophobic coating, an oleophilic coating, or any other suitable coating for increasing the efficiency of the filter device 42. In some aspects, the coating 72 may be positioned on a first side of the first screen 48, while a second, different coating may be positioned on one or both sides of the second screen 52, to more efficiently pass water through the filter device 42, while more efficiently preventing oils or other substances from passing through the filter device 42.

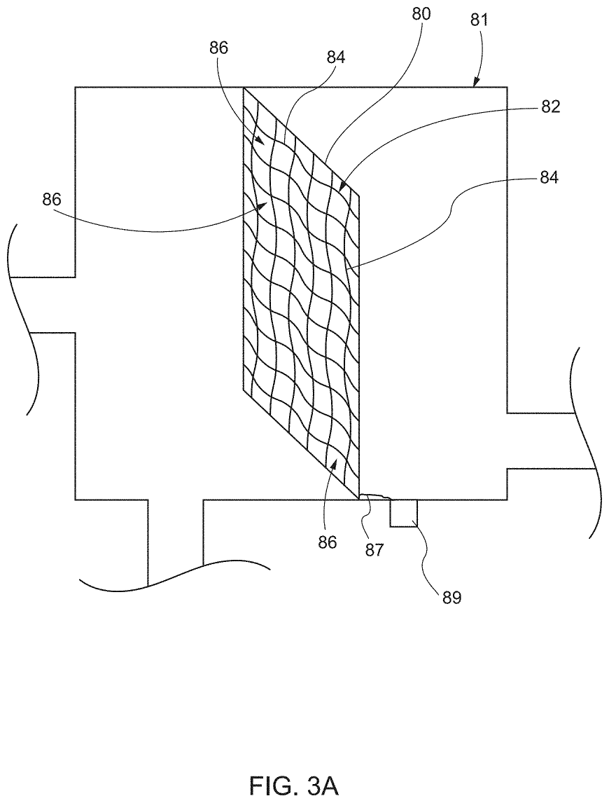

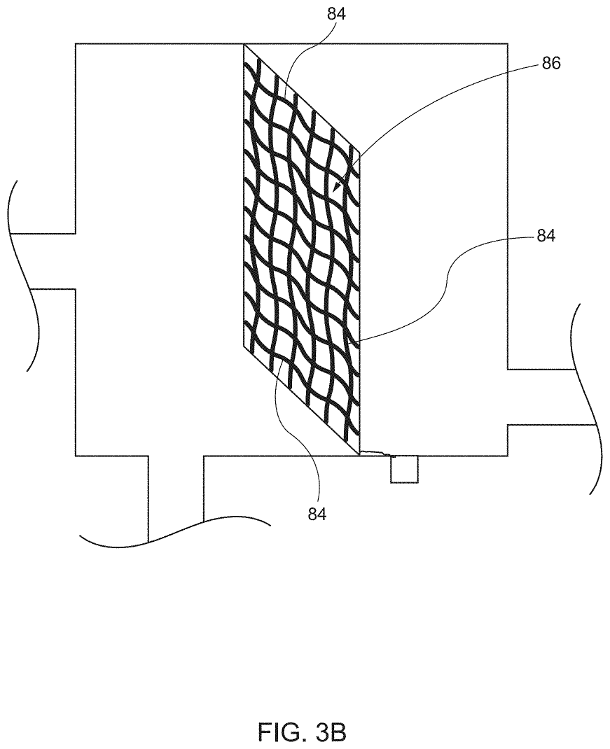

FIG. 3A depicts a filter device 80 positioned within a filter assembly 81. The filter device 80 comprises a filter membrane 82 for filtering substances such as toxic substances, or other materials that require special disposal or additional treatment prior to disposal, from a slop being filtered by the filter device 80. The filter membrane 82 includes a filter material 84 that intersects to define pores 86. The size of the pores 86 may be altered, for example increased or decreased, to filter out specific substances (e.g., oil, fracking fluid, etc.) from the slop by changing the size or dimensions of the pores 86 to prevent specific substances from passing through the pores 86.

By applying a stimulus to the filter material 84 the size or dimensions of the pores 86 may be altered, for example enlarged or made smaller. An amount of stimulus can also regulate the change in size of the pores 86. In some aspects, the stimulus may be an electrical voltage that may be transmitted to the filter material 84 via an electrical line 87. The electrical voltage may cause the filter material 84 to deform in a manner that alters the size or dimension of the pores 86, for example by twisting, expanding, retracting, or other suitable deformations. A controller 89 may control the application of the electrical voltage to the electrical line 87 and thereby to the filter material 84.

In one aspect of the present disclosure, the filter material 84 may be an electroactive polymer, including but not limited to polyelectrolytes (e.g. polyeletcrolyte hydrogels), polycations (PAH (polyalylehydrochloride), PAA poly(acrylic acid), PDDA poly(dimethyldiallyl ammonium chloride)), and polyanions (Amaranth, Rose Bengal, Congo red, Chicago sky blue). In some aspects, the filter material 84 may expand (as shown in FIG. 3B) in response to the application of the electrical voltage across the filter material 84. As shown in FIG. 3B, the size of the pores 86 have decreased as a result of the filter material 84 expanding in response to the application of the electrical voltage. Thus, the size and dimensions of the pores 86 can be increased or decreased by applying or removing a stimulus, for example via the application or removal of an electrical voltage across the filter material 84. In some aspects, the amount of electrical voltage can determine the degree to which the filter material 84 deforms, and thereby control the size and dimension of the pores 86.

The size and dimensions of the pores 86 can be increased or decreased to control which substances in the slop are filtered out by the filter material 84 for additional treatment or special disposal. The size of the pores 86 can also be increased to permit easy cleaning of the filter device 80, for example the filter material 84 may be cleaned by back flushing fluid to remove any substances or material trapped in the filter material 84. In some aspects, the size of the pores 86 can be increased by removing a stimulus, for example an electrical voltage. In still yet other aspects, the application of an electrical voltage may cause the pores 86 of the filter material 84 to decrease in size or in a particular dimension.

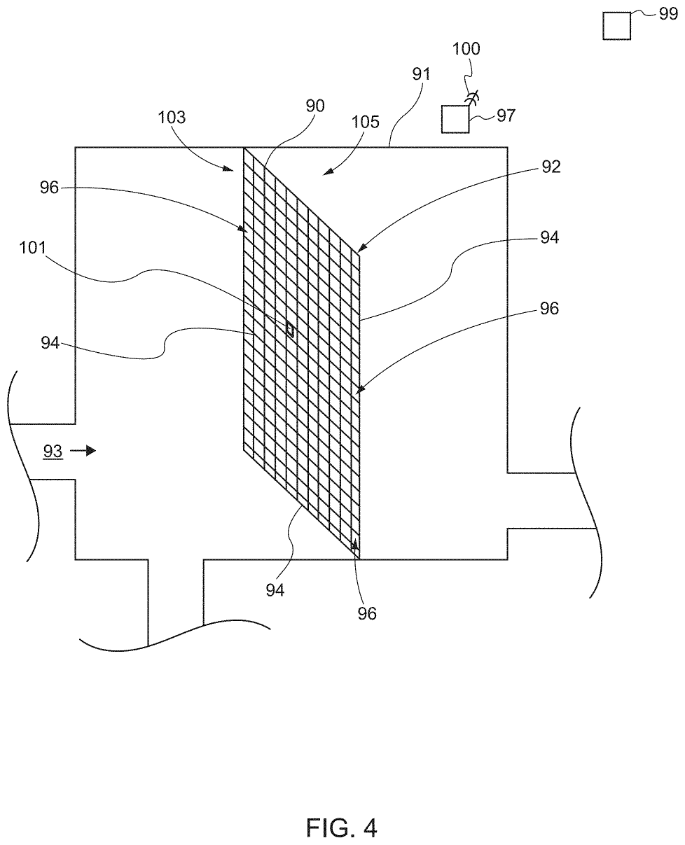

FIG. 4 depicts a filter device 90 within a filter assembly 91. The filter device 90 comprises a filter membrane 92 comprising a suitable material for filtering substances from a slop 93. The filter membrane 92 includes a filter material 94 that defines pores 96. The size of the pores 86 may be altered, for example increased, or decreased, to filter out specific substances from the slop 93 by changing the size of the pores 96 to a dimension or size that prevents a particular substance from passing through the pores 96.

In some aspects of the present disclosure, the size or dimension of the pores 96 may be altered by applying a stimulus to the filter material 94. The stimulus may include but is not limited to applying a change in temperature to the filter material 94, or in some aspects by stimulating the filter material 94 with a certain wavelength of light, or in still yet other aspects releasing a chemical that causes the filter material 94 to expand, retract, or otherwise deform or change in shape so as to alter the size, shape or dimension of the pores 96. In some aspects, the amount of stimulus can determine the degree to which the filter material 94 deforms, and thereby control the size and dimension of the pores 96. The filter material 94 may include, but is not limited to materials that react to thermal changes (e.g. poly(N-ispropylacrylamide) (PNIPAAM)), materials that react to light waves (e.g., spiropyrans and azobenzenes), materials that react to chemicals (e.g., polyelectrolytes, poly[3-carbamolyl-1-(p-vinylbenzyl)pyridinum choloride] (PCVPC), and Poly(methacrylic acid)). In other aspects, other suitable materials may be used.

The filter assembly 91 may include a signal-processing module or controller 97 that may control the application of the stimulus to the filter device 90 to alter the size or dimension of the pores 96. For example the controller 97 may include or communicate with a temperature transmitter for transmitting a change in temperature (e.g., applying heat or applying a coolant) to the filter device 90 to expand, retract or otherwise deform or change the shape of the filter material 94, thereby altering the size of the pores 96. For example, the filter material 94 may include thermosensitive polymers, for example but not limited to poly(N-ispropylacrylamide) (PNIPAAM). In some aspects, the controller 97 may transmit or communicate with a separate device that transmits a specific wavelength of light to the filter device 90 to cause the filter material 94 to expand, retract or otherwise deform or change shape, thereby altering the size of the pores 96. For example, the filter material 94 may include molecules with photochromatic properties or photoisomers, for example the filter material 94 may include spiropyrans and azobenzenes. In still yet other aspects, the controller 97 may release or cause another device to release a chemical that reacts with the filter material 94 of the filter device 90 to cause the filter material 94 to expand, retract or otherwise deform or change shape to alter the size of the pores 96. For example, the filter material 94 may include polyelectrolytes, PCVPC, and Poly(methacrylic acid). In some aspects, the controller 97 may control the release of ions to adjust the pH or oxidation of the filter material 94. Thus, the size and dimensions of the pores 96 can be increased or decreased via the application of a stimulus to selectively filter out specific substances from the slop. In some aspects, the amount of the stimulus can also determine the resulting size and dimension of the pores 86. The size of the pores 96 can also be altered to permit easy cleaning of the filter device 90, for example by enlarging the pores 96 and back flushing a fluid through the filter membrane 92 to remove any substances or material trapped therein. By providing a means for cleaning the filter device 90 without removing the filter device 90 from the filter assembly 91, the filter assembly 91 may be used more efficiently without as much down time require to clean the filter device 90 prior to filtering a new application of slop.

The controller 97 may be communicatively coupled to a computing device 99 via a wireless communication link 100 located away from the filter assembly 91. The controller 97 may receive a signal from the computing device 99 that may correspond to an instruction for applying a stimulus to the filter material 94. In some aspects, the wireless communication link 100 may instead be a wired communication link.

In some aspects, a filter device or a filter assembly, for example the filter device 90 shown in FIG. 4, may include a sensor 101. The sensor 101 while shown on a first side 103 of the filter device 90 of the filter assembly 91 in FIG. 4, may be located in any other suitable position on either the filter device 90 or the within the filter assembly 91. In still yet other aspects, the sensor 101 may be positioned elsewhere, for example but not limited to in a pathway through which the slop 93 is transported to the filter assembly 91. The sensor 101 may determine the presence of various substances within the slop 93. The sensor 101 may transmit a signal to the controller 97 indicating which substances (e.g., oils, fracking fluid, emulsifiers, polymers, etc.) are present in the slop 93. This information may be used to determine what substances need to be filtered from the slop 93. The size of the pores 96 can be selected based on which substances are known to be in the slop 93 as determined by the sensor 101 to be present in the slop 93. The controller 97 can transmit this information to the computing device 99 and the computing device 99 may in turn transmit a signal to the controller 97 instructing the controller 97 to apply a stimulus to the filter device 90 to alter the size of the pores 96 based on the substance desired to be filtered from the slop 93. For example, the computing device 99 may transmit a signal to the controller 97 instructing the controller 97 to apply a stimulus to the filter device 90 that will cause the size of the pores 96 to be smaller than the size of the substance desired to be filtered out from the slop 93.

In some aspects, the sensor 101 or an additional sensor may be positioned on a second side 105 of the filter device 90 to determine what substances have passed through the filter device 90. For example, the sensor 101 may detect an unwanted substance that has not been filtered out by the filter device 90 and instead has passed through the pores 96 of the filter device 90 to the second side 105 of the filter device 90. This information can help determine if the size of the pores 96 should be changed to prevent such a substance from passing through the filter device 90.

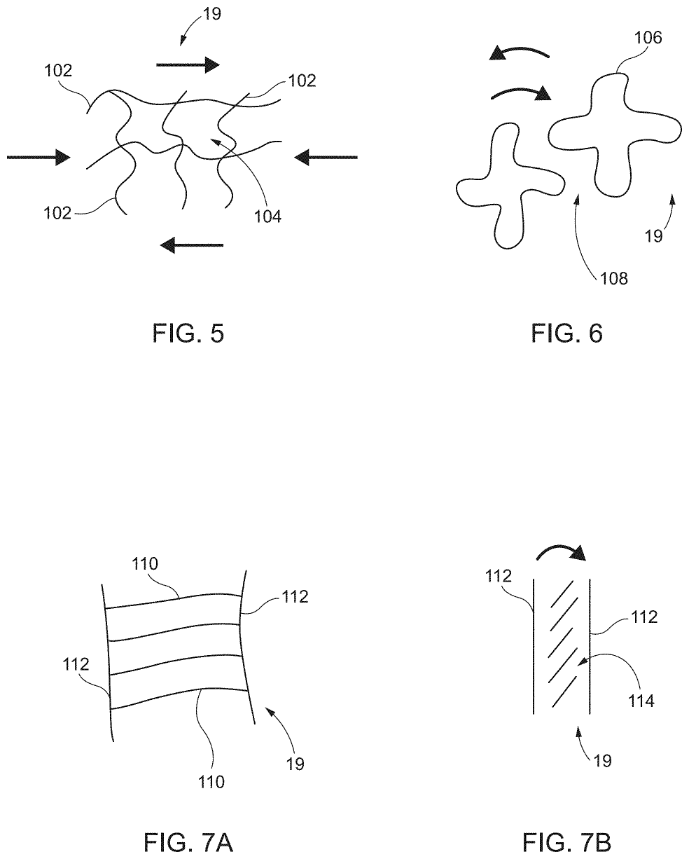

FIG. 5 depicts a portion of a filter device, for example filter device 19 comprising a plurality of fibers, strands, wires, or other suitable materials, for example strands 102. The strands 102 may stretch in one or more directions which may cause the size and aspect ratio of a passageway or pore 104 through the filter device 19. The strands 102 can be deformed to define a desired size of passageway or pore 104. In some aspects, the strands 102 can be deformed in response to a signal from a signal processing module (for example controller 30).

FIG. 6 depicts a portion of a filter device, for example filter device 19 that includes an array of wires 106 having a cross-sectional shape that can affect a size and ratio of a passageway (or pore) 108 between adjacent wires 106 of the filter device 19 and thereby prevent certain materials from passing through the filter device 19. The orientation of the wires 106 relative to one another in the array may affect the size and aspect ratio of the passageway 108 between the wires of the filter device 19. For example, the wires 106 may have a cross-sectional shape as shown in FIG. 6 which may result in a change of the size and aspect ratio of the passageway 108 based at least in part on the position of the wires 106 along their longitudinal axis.

FIGS. 7A and 7B depicts a portion of a filter device, for example filter device 19, including a plurality of strips (or blades) 110. The strips 110 can be positioned within a housing 112. FIG. 7A depicts a front view of the portion of the filter device 19 and FIG. 7B depicts a side view of the portion of the filter device 19. As shown in FIG. 7B, the orientation of each of the plurality of strips relative to one another can determine the size of a passageway (or pore) 114 between each of the strips. For example, twisting the strips 110 about their axis may change at least one of the size and aspect ratio of the passageway 114 between adjacent strips 110. A second screen of strips 110 may also be included in the filter device 19 to further control the size and aspect ratio of passageways 114 through the filter device 19.

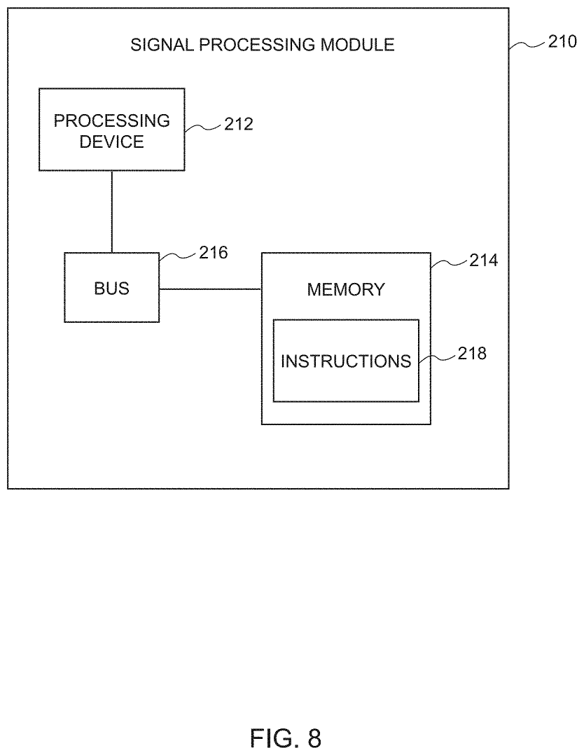

FIG. 8 is a block diagram depicting an example of a signal-processing module 210 according to one aspect of the present disclosure. The signal-processing module 210 includes a processing device 212, a memory device 214, and a bus 216.

The processing device 212 can execute one or more operations for determining a substance associate with a signal from a sensor, for example but not limited to determining a position for a screen of a filter device, determining a stimulus to transmit to the filter device and transmitting a stimulus to the filter device, and transmitting a signal to a motor in response to determining a position for a screen of a filter device. The processing device 212 can execute instructions 218 stored in the memory device 214 to perform the operations. The processing device 212 can include one processing device or multiple processing devices. Non-limiting examples of the processing device 212 include a Field-Programmable Gate Array (“FPGA”), an application-specific integrated circuit (“ASIC”), a microprocessor, etc.

The processing device 212 can be communicatively coupled to the memory device 214 via the bus 216. The non-volatile memory device 214 may include any type of memory device that retains stored information when powered off. Non-limiting examples of the memory device 214 include EEPROM, flash memory, or any other type of non-volatile memory. In some aspects, at least some of the memory device 214 can include a medium from which the processing device 212 can read the instructions 218. A computer-readable medium can include electronic, optical, magnetic, or other storage devices capable of providing the processing device 212 with computer-readable instructions or other program code. Non-limiting examples of a computer-readable medium include (but are not limited to) magnetic disk(s), memory chip(s), ROM, RAM, an ASIC, a configured processor, optical storage, or any other medium from which a computer processor can read instructions. The instructions may include processor-specific instructions generated by a compiler or an interpreter from code written in any suitable computer-programming language, including, for example, C, C++, C#, etc.

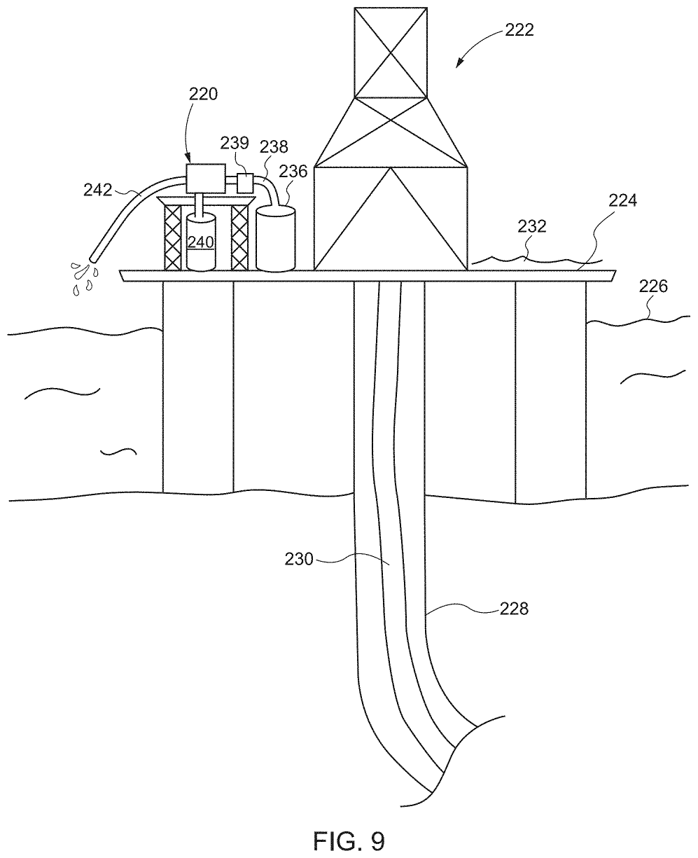

FIG. 9 depicts an application of a filter system 220 in a wellbore system 222, according to an aspect of the present disclosure. The filter system 220 can be, for example, the filter system 10 and can include any one of the filter devices shown and described in FIGS. 2A-7B. The wellbore system 222 includes a platform 224 (sometimes referred to as a rig). In the aspect shown in FIG. 9, the platform 224 is located above water 226, however in other aspects the platform 224 may be over land. A wellbore 228 extends through the earth. A tubing string 230 is positioned within the wellbore 228 for returning fluid from the wellbore to the platform 224. During drilling and completion of the wellbore 228, as well as during the life of the wellbore system 222 fluid, for example waste water 232 collects on the platform 224. For example, the water waste 232 can be rain water mixed with fracking fluid or other drilling fluid. In addition fracking fluid and other drilling fluid may mix with other fluids and may be collected during the lifetime of the wellbore 228 can form waste water 232 that is treated prior to disposal.

The waste water 232 can be collected in a storage container 236 for filtering using the filter system 220. As shown in FIG. 9, the waste water 232 can flow through a flow path 238 (e.g. a tubing or piping) from the storage container 136 into the filter system 220. In some aspects, a pump 239 may aid in moving the waste water 232 from the container 236 to the filter system 220. The filter system 220 can filter substances from the waste water 232. The substances that are removed from the waste water 232 by the filter system 220 can exit the filter system 220 into a storage container 240. Those substances collected in the storage container 240 can then be transported for further treatment prior to disposal. The filtered water that has passed through the filter system 220 can exit the filter system 220 via a tubing 242 and be disposed of into the ocean, as shown in FIG. 9. In other aspects, the filtered water that has passed through the filter system 220 can be collected and disposed of in another suitable manner.

Example No. 1: A filter assembly may include a housing in fluid communication with an inlet for receiving a waste water from a wellbore. The assembly may also include a filter device for filtering a substances from the waste water, the filtering device comprising a plurality of pores having dimensions defining a first area. The filter device may be configurable in response to stimulus for altering the dimensions of the plurality of pores of the filter device to define a second area that is different from the first area.

Example No. 2: The filter assembly of Example No. 1 may further feature a signal-processing module coupled to the filter device, the signal-processing module having a non-transitory, computer-readable medium on which is code that is executable to cause the signal-processing module to transmit the stimulus to the filter device for altering the dimensions of the plurality of pores to define the second area that is different from the first area.

Example No. 3: The filter assembly of Example No. 1 or Example No. 2 may further feature the filter device comprising a first filter screen having a plurality of first openings and a second filter screen having a plurality of second openings. An overlap between the plurality of first openings and the plurality of second openings defines the plurality of pores in the filter device. The stimulus may be a signal to a motor to position the first filter screen adjacent the second filter screen at a desired position to define the second area of the plurality of pores of the filter device.

Example No. 4: The filter assembly of any of Example Nos. 1-3 may further feature the desired area of the plurality of pores being 0.1 μm to 100 μm.

Example No. 5: The filter assembly of any of Examples Nos. 1-2 may further feature the stimulus being an electrical voltage for deforming the filter device such that the plurality of pores have the second area.

Example No. 6: The filter assembly of Example No. 5 may further feature the filter device being comprised of at least one polyelectrolyte.

Example No. 7: The filter assembly of any of Examples Nos. 1-2 may further feature the stimulus being an increase in temperature of a filter device for deforming the filter device such that the plurality of pores have the second area.

Example No. 8: The filter assembly of Example No. 7 may further feature the filter device being comprised of at least one thermosensitive polymer.

Example No. 9: The filter assembly of any of Examples Nos. 1-2 may further feature the stimulus being a select wavelength of light for deforming the filter device such that the plurality of pores have the second area.

Example No. 10: The filter assembly of Example No. 9 may further feature the filter device being comprised of at least one of photochromatic properties and photoisomers.

Example No. 11: The filter assembly of any of Examples Nos. 1-2 may further feature the stimulus being a chemical compound for reacting filter device such that the plurality of pores have the second area.

Example No. 12: The filter assembly of Example No. 11 may further feature the filter device being comprised of at least one of polyelectrolytes, PCVPC, and Poly(methacrylic acid).

Example No. 13: The filter assembly of any of Examples Nos. 1-12 may further feature a coating on a surface of the filter device.

Example No. 14: The filter assembly of Example No. 13 may further feature the coating comprises a hydrophobic coating or an oleophilic coating.

Example No. 15: The filter assembly of any of Example Nos. 1-14 may further feature a sensor communicatively coupled to the signal-processing module for detecting a substance in the waste water.

Example No. 16: A filtration system may include a signal-processing module for filtering substances from a fluid from a wellbore, the signal-processing module being coupled to a filter device having a plurality of pores having dimensions defining a first area, the signal-processing module having a non-transitory, computer-readable medium on which is code that is executable to cause the signal-processing module to transmit a stimulus to the filter device for altering the dimensions of the plurality of pores to define a second area that is different from the first area.

Example No. 17: The filtration system of Example No. 16 may further feature the stimulus being a select wavelength of light for deforming the filter device such that the plurality of pores have the second area.

Example No. 18: The filtration system of Example No 16 may further feature the stimulus being an electrical voltage for deforming the filter device such that the plurality of pores have the second area.

Example No. 19: The filtration system of Example No. 16 may further feature the stimulus being an increase in temperature of the filter device for deforming the filter device such that the plurality of pores have the second area.

Example No. 20: The filtration system of Example No. 16 may further feature the stimulus being a chemical compound for reacting with the filter device for deforming the filter device such that the plurality of pores have the second area.

The foregoing description of certain aspects, including illustrated aspects, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A filter assembly comprising:
a housing in fluid communication with an inlet for receiving a waste water from a wellbore; and
a filter device for filtering a substances from the waste water, the filtering device comprising a plurality of pores having dimensions defining a first area, wherein the filter device is configurable in response to stimulus for altering the dimensions of the plurality of pores of the filter device to define a second area that is different from the first area.

2. The filter assembly of claim 1 further comprising:
a signal-processing module coupled to the filter device, the signal-processing module having a non-transitory, computer-readable medium on which is code that is executable to cause the signal-processing module to:
transmit the stimulus to the filter device for altering the dimensions of the plurality of pores to define the second area that is different from the first area.

3. The filter assembly of claim 1, wherein the filter device comprises a first filter screen having a plurality of first openings and a second filter screen having a plurality of second openings, wherein an overlap between the plurality of first openings and the plurality of second openings defines the plurality of pores in the filter device; and
wherein the stimulus is a signal to a motor to position the first filter screen adjacent the second filter screen at a desired position to define the second area of the plurality of pores of the filter device.

4. The filter assembly of claim 1, wherein the desired area of the plurality of pores is 0.1 μm to 100 μm.

5. The filter assembly of claim 1, wherein the stimulus is an electrical voltage for deforming the filter device such that the plurality of pores have the second area.

6. The filter assembly of claim 5, wherein the filter device is comprised of at least one polyelectrolyte.

7. The filter assembly of claim 1, wherein the stimulus is an increase in temperature of a filter device for deforming the filter device such that the plurality of pores have the second area.

8. The filter assembly of claim 7, wherein the filter device is comprised of at least one thermosensitive polymer.

9. The filter assembly of claim 1, wherein the stimulus is a select wavelength of light for deforming the filter device such that the plurality of pores have the second area.

10. The filter assembly of claim 9, wherein the filter device is comprised of at least one of photochromatic properties and photoisomers.

11. The filter assembly of claim 1, wherein the stimulus is a chemical compound for reacting filter device such that the plurality of pores have the second area.

12. The filter assembly of claim 11, wherein the filter device is comprised of at least one of polyelectrolytes, PCVPC, and Poly(methacrylic acid).

13. The filter assembly of claim 1, further comprising a coating on a surface of the filter device.

14. The filter assembly of claim 13, wherein the coating comprises a hydrophobic coating or an oleophilic coating.

15. The filter assembly of claim 1, further comprising a sensor communicatively coupled to the signal-processing module for detecting a substance in the waste water.

16. A filtration system comprising:
a signal-processing module for filtering substances from a fluid from a wellbore, the signal-processing module being coupled to a filter device having a plurality of pores having dimensions defining a first area, the signal-processing module having a non-transitory, computer-readable medium on which is code that is executable to cause the signal-processing module to:
transmit a stimulus to the filter device for altering the dimensions of the plurality of pores to define a second area that is different from the first area.

17. The filtration system of claim 16, wherein the stimulus is a select wavelength of light for deforming the filter device such that the plurality of pores have the second area.

18. The filtration system of claim 16, wherein the stimulus is an electrical voltage for deforming the filter device such that the plurality of pores have the second area.

19. The filtration system of claim 16, wherein the stimulus is an increase in temperature of the filter device for deforming the filter device such that the plurality of pores have the second area.

20. The filtration system of claim 16, wherein the stimulus is a chemical compound for reacting with the filter device for deforming the filter device such that the plurality of pores have the second area.
